(19) United States
(12) Patent Application Publication
(10) Pub. No.: US 2011/0233147 A1
(43) Pub. Date: Sep. 29, 2011

(54) METHOD AND APPARATUS FOR PRODUCING HIGH-PURITY WATER FROM LOW-PURITY WATER

(75) Inventors: Shigeto HAYAFUJI, Tokyo (JP); Hideyuki HASHIZUME, Tokyo (JP)

(73) Assignee: CDM CONSULTING CO., LTD., Tokyo (JP)

(21) Appl. No.: 13/017,842

(22) Filed: Jan. 31, 2011

Related U.S. Application Data
(63) Continuation-in-part of application No. PCT/JP2009/063898, filed on Jul. 30, 2009.

(30) Foreign Application Priority Data
Jul. 31, 2008 (JP) 2008-197395

(51) Int. Cl. C02F 1/68; C02F 103/08

(52) U.S. Cl. 210/766; 210/205

(57) ABSTRACT

A method produces high-purity water from low-purity water, which is not limited to seawater but includes sewage. The method includes having one or more types of gases capable of forming gas hydrates and low-purity water come into contact under conditions in which the temperature is higher than the freezing point of the low-purity water and the gas hydrates can be formed, thereby producing solid gas hydrates which are suspended in the low-purity water. The low-purity water used in the gas hydrate formation process is removed while substantially maintaining the gas hydrate state. Components adhered to the gas hydrates are cleansed with cleansing water; and by increasing the temperature in the gas hydrate state or decreasing the pressure in the gas hydrate state, the gas hydrates are decomposed into a gas and high-purity water.

### CROSS REFERENCE TO RELATED APPLICATION

This application is a continuation-in-part of International Application No. PCT/JP2009/063898 filed Jul. 30, 2009, which claims priority to Japanese Patent Application No. 2008-197395, filed Jul. 31, 2008 the entire contents of all of which are incorporated by reference as if fully set forth.

### TECHNICAL FIELD

The present invention relates to a method and an apparatus for producing a high-purity water from a low-purity water.

### BACKGROUND ART

Recently, the world has been short of sweet water. On the other hand, the earth has sufficient water containing numerous impurities, such as seawater and sewage. There has been a strong demand for producing a high-purity water such as sweet water from a low-purity water and some seawater desalination technologies have been known so far. However, all of them have technical difficulties.

Examples of seawater desalination technologies include: an evaporation process in which seawater is heated using a heat source to generate steam, after which the steam is cooled to obtain fresh water; and a membrane process in which salt in seawater is removed using a membrane.

The evaporation process has problems in that it requires a great amount of heat for water evaporation and that the heated seawater causes corrosion of equipment.

The membrane process also has a problem in that it is difficult to find materials for semi-permeable membranes excellent in salt tolerance and durability and that are impermeable to salt, and has a further drawback of requiring the application of a pressure on seawater of usually up to 6-7 MPa before supplying seawater to a reverse osmosis membrane module.

Other seawater desalination technologies include, for example, freezing processes, solar energy processes, and a gas hydration process (Japanese Unexamined Patent Application Publication No.HEI11-319805). However, these technologies are still in the developing stages and there have been no reports of any of these technologies being put into practical use for producing drinking water.

Gas hydrate—alternatively called clathrate hydrate—is a compound in which a hydrate-forming gas molecule is trapped within a cage-like crystal lattice formed by hydrogen-bonded water molecules, and gas hydrate is an ice-like solid clathrate formed under a condition of a temperature and a pressure.

The lower the temperature at which gas hydrate is formed, the lower the pressure needed. However, because water turns into ice below its freezing point, the speed of hydrate formation in ice is lower than that in water. There is a technology that uses seawater—its freezing point being −4° C.—and causes hydrate to be formed at a temperature slightly higher than the freezing point of the water. In this technology, a gas capable of forming hydrate under the above condition is selected, hydrate is formed, and because molecules constituting the cage-like crystals of the hydrate are pure water molecules, it has seemed that fresh water can be obtained from the hydrate.

However this technology has not been yet in practical implementation. The idea is excellent but it seems that some problems still remain that prevent implementation.

Meanwhile, some other desalination technologies are described in “Clathrate Hydrate of Natural Gases, Third Edition, 2007” by E. Dendy Sloan Jr. However, none of the technologies is at an industrial stage. This document includes a report of fifteen years of research into seawater desalination, and shows the difficulties in seawater desalination technologies.

Prior Art Documents

Patent Document

Patent Document 1: Japanese Unexamined Patent Application Publication No.HEI11-319805)

Non-patent Document

Non-patent Document 1: Clathrate Hydrate of Natural Gases, Third Edition, 2007, by E. Dendy Sloan Jr.

### SUMMARY OF THE INVENTION

### Problem to be Solved by the Invention

Therefore, it is a first object of the present invention to solve the problems of technologies for obtaining fresh water from gas hydrate using seawater, and obtains, based on findings, a high-purity water from a low-purity water, the low-purity water being not limited to seawater and also including sewage.

It is a second object of the present invention to provide a method for obtaining water at a level suitable for drinking water.

The objects and aspects, as well as the several advantages of this invention are apparent from a study of the disclosure and appended claims.

### Means for Solving the Problem

The present invention has been based on the following findings. More specifically, as a result of further testing of the seawater desalination technology disclosed in Japanese Unexamined Patent Application Publication No. HEI11-319805, what was obtained was a water with salinity only slightly reduced, which could not be used as drinking water, and it has been found that the same outcome results even when performing the seawater desalination in multiple stages.

Note that the term “a low-purity water” used in the present invention refers to a water containing numerous impurities such as seawater and sewage, and the term “a high-purity water” refers to a water with a purity higher than the low-purity water. A high-purity water is not limited to drinking water such as sweet water.

In the above-mentioned prior art, the term “fresh water” is used as opposed to seawater. However, the present invention is not limited to seawater desalination. Therefore, the term “a high-purity water” is used instead of fresh water.

The present invention has been obtained from years of fundamental research in water obtained from gas hydrate. Some gas hydrates can reach a size of about several hundred microns with crystal growth, but other hydrates do not reach that size.

It is known that the gas hydrate has the following crystal structures: structure I consists of a primitive cubic lattice of 12 Å on a side; structure II consists of a face-centered cubic lattice of 17.3 Å on a side; and structure H consists of a hexagonal lattice, where a=12.3 Å, c=10.2 Å.

Therefore, gas hydrate forms a group of crystals having such a crystal structure. Assuming that a gas hydrate forms a sphere with diameter of 50 μm and that each crystal structure is a cubic system of 15 Å on a side, at least trillions of the crystal structures exist in the sphere.

A crystal structure of a gas hydrate includes only water molecules and a gas molecule, and salt is excluded from the crystal structure. Relatively slow crystal growth expels salt to the outside of the crystal structure, while rapid crystal growth may possibly leave salt between microcrystalline structures.

It is extremely difficult to cleanse gas hydrate of salt adhered to the outside of the crystal structure inside a gas hydrate. Meanwhile, it has been discovered that salt in structure II is less likely to remain inside than in other structures. However, it also has been discovered that it is not easy to produce a high-purity water even with structure II. In other words it has been discovered that salt deposited on the outside of the gas hydrate crystal is fixedly adhered and it cannot be removed by a simple cleansing process. However, the present inventor found in the research that sufficiently-cleansed gas hydrate can produce water of a high-purity level sufficient for drinking water. Rinsing taught in the prior art is far from sufficient. If an appropriate cleansing method is used, it was proved to obtain water of a high purity level sufficient for drinking water.

Upon producing a high-purity water suitable for drinking water from a low-purity water, it is necessary to cleanse a gas hydrate with a high-purity water having the amount of smaller than that of the high-purity water to be obtained. In response to this demand and based on the above findings, the inventors have reached the invention described below.

(1) A first method for producing a high-purity water from a low-purity water includes the steps of:
producing a gas hydrate suspended in the low-purity water by having a gas capable of forming the gas hydrate and the low-purity water come into contact under a condition of forming the gas hydrate and in a temperature higher than the freezing point of the low-purity water;
cleansing the gas hydrate of impurities adhered to the gas hydrate with a cleansing water up to the level that the high-purity water to be obtained by a subsequent process is a drinking water while substantially maintaining the gas hydrate state; and
decomposing the gas hydrate into a gas and the high-purity water to be obtained by at least one of increasing the temperature in the gas hydrate state and decreasing the pressure in the gas hydrate state,
these steps carried out in the above order.

With the above method for producing a high-purity water from a low-purity water according to the invention, the amount of resulting a high-purity water suitable for drinking water is several times larger than that of the high-purity water suitable for drinking water but used for the production. Moreover, waste water generated in the production process can be recycled as, for example, agricultural water, industrial water, or household water.

(2) A second method for producing a high-purity water from a low-purity water is characterized in that it further includes a step of selecting a gas that forms a gas hydrate of structure II, and the selected gas is used in the step of producing the gas hydrate.

With the present invention, impurities are unlikely to be deposited inside the gas hydrate and a high-purity water can be obtained easily.

(3) A third method for producing a high-purity water from a low-purity water is characterized in that the cleansing water is a low-purity water in the beginning and is changed to a water with higher purity gradually or in set order.

With the above method for producing a high-purity water from a low-purity water according to the invention, it is feasible to obtain a high-purity water suitable for drinking water while reducing to a lower level the amount of the high-purity water suitable for drinking water but used for the production.

(4) A fourth method for producing a high-purity water from a low-purity water is characterized in that the step of cleansing the gas hydrate includes the step of:
preparing a cleansing tank,
removing the low-purity water used for forming the gas hydrate from said cleansing tank, remaining the gas hydrate,
supplying a low-purity water different from the low-purity water used for forming the gas hydrate to said cleansing tank,
agitating the gas hydrate and the low-purity water different from the low-purity water used for forming the gas hydrate; and
removing the above-stated low-purity water containing dissolved impurities deposited on the surfaces of the gas hydrate.

With the above method for producing a high-purity water from a low-purity water according to the invention, it is feasible to obtain a high-purity water suitable for drinking water while reducing to a lower level the amount of the high-purity water suitable for drinking water but used for the production.

(5) A fifth method for producing a high-purity water from a low-purity water is characterized in that the step of cleansing the gas hydrate includes the steps of:
preparing a net-like substrate,
piling up the gas hydrate on said net-like substrate,
showering a high-purity water different from the high-purity water to be obtained on the gas hydrate and,
removing from the cleansing site the upper gas hydrate from the cleansing site, utilizing the buoyancy of the gas hydrate having a specific gravity smaller than that of the showered high-purity water.

With the above method for producing a high-purity water from a low-purity water according to the invention, if the specific gravity of the formed gas hydrate is smaller than that of water, it is feasible to obtain a high-purity water suitable for drinking water while reducing to a lower level the amount of the high-purity water suitable for drinking water but used for the production.

(6) A sixth method for producing a high-purity water from a low-purity water is characterized in that the step of cleansing the gas hydrate includes the steps of:
preparing a cleansing tank,
supplying the gas hydrate upward from a bottom part of said cleansing tank,
showering a high-purity water different from the high-purity water to be obtained, on the gas hydrate, and
removing the upper gas hydrate from the site of cleansing, using buoyancy of the gas hydrate having a specific gravity smaller than that of said showered high-purity water.

With the above method for producing a high-purity water from a low-purity water according to the invention, if the specific gravity of the formed gas hydrate is smaller than that of water, it is feasible to produce to a high-purity water suitable for drinking water while reducing to a lower level the amount of the high-purity water suitable for drinking water but used for the production.

(7) A seventh method for producing a high-purity water from a low-purity water is characterized in that the step of cleansing the gas hydrate includes the steps of:
preparing a net-like substrate,
piling up the gas hydrate on said net-like substrate,
spreading the gas hydrate piled upon said net-like substrate so as to form a thin plate-like appearance,
spraying a high-purity water different from the high-purity water to be obtained, on said spread gas hydrate, and
draining the sprayed high-purity water through the net of the net-like substrate.

With the above method for producing a high-purity water from a low-purity water according to the invention, it is feasible to produce a high-purity water suitable for drinking water while reducing to a much lower level the amount of the high-purity water suitable for drinking water but used for the production.

(8) An eighth method for producing a high-purity water from a low-purity water is characterized in that the low-purity water is seawater.

With the above method for producing a high-purity water from a low-purity water according to the invention, the amount of resulting a high-purity water suitable for drinking water is several times larger than that of the high-purity water suitable for drinking water but used for the production.

(9) A ninth method for producing a high-purity water from a low-purity water is characterized in that the low-purity water is sewage.

With the above method for producing a high-purity water from a low-purity water according to the invention, the amount of resulting a high-purity water suitable for drinking water is several times larger than that of the high-purity water suitable for drinking water but used for the production.

(10) A tenth method for producing a high-purity water from a low-purity water is characterized in that a gas hydrate formed with isobutane is of structure II.

A gas hydrate formed with isobutane of structure II is easy to make an efficient production of a high-purity water that is suitable for drinking.

(11) An eleventh method for producing a high-purity water from a low-purity water is characterized in that the gas hydrate is formed under a condition of temperature 3-5° C. and a pressure 3-5 MPa.

Under the condition, it is feasible to produce a high-purity water that is suitable for drinking more easily.

(12) A first apparatus for a producing a high-purity water from a low-purity water, includes:
a supply unit for supplying a raw material comprising a gas and the low-purity water for a gas hydrate;
a gas hydrate formation tank for forming the gas hydrate under a condition for gas hydrate formation;
a cleansing tank capable of serving also as the gas hydrate formation tank, for removing the low-purity water used in the gas hydrate formation and cleansing the gas hydrate of impurities deposited on an external wall of the gas hydrate with a cleansing water while substantially maintaining the gas hydrate up to the level that the high-purity water to be obtained is a drinking water; and
a gas hydrate decomposition tank for obtaining the high-purity water by at least one of increasing a temperature and decreasing a pressure in the gas hydrate state.

With the above apparatus for producing a high-purity water from a low-purity water according to the invention, the amount of resulting a high-purity water suitable for drinking water is several times larger than that of the high-purity water suitable for drinking water but used for the production.

(13) A second apparatus for producing a high-purity water from a low-purity water is characterized in that the cleansing tank includes a cleansing tank for cleansing the gas hydrate with the low-purity water, and a cleansing apparatus with a high-purity water different from the high-purity water to be obtained, for cleansing the gas hydrate cleansed with the low-purity water.

With the above apparatus for producing a high-purity water from a low-purity water according to the invention, it is possible to produce a high-purity water suitable for drinking water while reducing to a lower level the amount of the high-purity water suitable for drinking water but used for the production.

(14) A third apparatus for producing a high-purity water from a low-purity water is characterized in that the cleansing tank for cleansing the gas hydrate with a low-purity water includes an agitation unit, an outlet for the low-purity water after agitation, and an inlet for a new low-purity water.

(15) A fourth apparatus for producing a high-purity water from a low-purity water is characterized in that the cleansing apparatus for cleansing the gas hydrate with a high-purity water different from the high-purity water to be obtained, comprising:
means for piling up the gas hydrate on a net-like substrate,
means for supplying the gas hydrate upward,
means for showering a high-purity water different from the high-purity water to be obtained on the gas hydrate, and
means for transporting the gas hydrate having a specific gravity smaller than that of said showered high-purity water from an outlet provided in an upper part of the side wall of the cleansing tank to the hydrate decomposition tank.

With the above apparatus for producing a high-purity water from a low-purity water according to the invention, it is feasible to produce a high-purity water suitable for drinking water while reducing to a lower level the amount of the high-purity water suitable for drinking water but used for the production.

(16) A fifth apparatus for producing a high-purity water from a low-purity water is characterized in that the cleansing apparatus for cleansing the gas hydrate with a
high-purity water different from the high-purity water to be obtained, comprising:
means for supplying the gas hydrate upward from a bottom part of the cleansing tank,
means for showering a high-purity water different from the high-purity water to be obtained, on the gas hydrate, and
means for transporting the upper gas hydrate having a specific gravity smaller than said showered high-purity water from an outlet provided in an upper part of the side wall of the cleansing tank to the hydrate decomposition tank.

With the above apparatus for producing a high-purity water from a low-purity water according to the invention, it is feasible to produce a high-purity water suitable for drinking water while reducing to a lower level the amount of the high-purity water suitable for drinking water but used for the production.

(17) A sixth apparatus for producing a high-purity water from a low-purity water is characterized in that the cleansing apparatus for cleansing the gas hydrate with a high-purity water different from the high-purity water to be obtained comprising:
means for piling up the gas hydrate on a net-like substrate,
means for spreading the gas hydrate piled upon the net-like substrate so as to form a thin plate-like appearance,
means for spraying on said spread gas hydrate a high-purity water different from the high-purity water to be obtained, and
means for draining the sprayed high-purity water through the net of the net-like substrate.

With the above apparatus for producing a high-purity water from a low-purity water according to the invention, it is feasible to produce a high-purity water suitable for drinking water while reducing a lower level the amount of the high-purity water suitable for drinking water but used for the production.

(18) A seventh apparatus for producing a high-purity water from a low-purity water, is characterized in that the net-like substrate is of a belt conveyor type.

With the above apparatus for producing a high-purity water from a low-purity water, it is feasible to produce a high-purity water continuously.

(19) An eighth apparatus for producing a high-purity water from a low-purity water is characterized in that the cleansing tank includes:
an agitation wing and an agitation axis in a lower part of the cleansing tank;
a funnel in an upper central part; and
a communicating tube extending from a bottom part of the funnel through a side wall of the cleansing tank to a section for the subsequent process so that the gas hydrate cleansed in agitation travels through the communicating tube from an upper end of the funnel to a section for the subsequent process.

With the above apparatus for producing a high-purity water from a low-purity water, it is feasible to smoothly transport the formed gas hydrate under a condition in which the gas hydrate is maintained.

(20) A ninth apparatus for producing a high-purity water from seawater, includes:
a double tube of a length reaching the deep sea wherein a gas hydrate is formed in its tip, the double tube including:
an internal tube which a raw material gas for a gas hydrate is supplied to; and an external tube which the formed gas hydrate passes through,
the double tube also having a space allowing to enter the gas between the internal tube and the external tube through a pore in a vicinity of the tip of the internal tube; and
a porous film permeable to seawater at the tip of the external tube;
a cleansing tank for removing the seawater used in the gas hydrate formation and cleansing the gas hydrate with cleansing water up to the level that the high-purity water to be obtained is a drinking water while substantially maintaining the gas hydrate state; and
a gas hydrate decomposition tank for obtaining high-purity water by at least one of increasing the temperature and decreasing the pressure in the gas hydrate state which has been kept for the gas hydrate.

With the above apparatus for producing a high-purity water from a low-purity water according to the invention, it is feasible to obtain a high-purity water from a gas hydrate in the subsurface part of sea.

(21) A tenth apparatus for producing a high-purity water from seawater, is characterized in that the cleansing tank includes a cleansing tank for cleansing the gas hydrate with a low-purity water, and a cleansing apparatus for cleansing the gas hydrate cleansed with the low-purity water, with a high-purity water different from the high-purity water to be obtained.

With the above apparatus for producing a high-purity water from a low-purity water according to the invention, it is feasible to obtain a high-purity water from a gas hydrate in the subsurface part of sea while reducing the amount of high-purity water suitable for drinking water but used for the production.

### Effects of the Invention

According to the invention, it is feasible to produce a high-purity water suitable for drinking water—water containing impurities of not more than 100 ppm when expressed numerically—from a low-purity water such as seawater and sewage can be obtained. By the way, average tap water contains impurities of 40-200 ppm and famous natural water, spring water and ideal drinking water contain impurities of not more than 39 ppm. Waste water generated during the production process this invention can be used as, for example, agricultural water, industrial water, or household water. Moreover, as long as the process is carried out properly, the amount of resulting a high-purity water suitable for drinking water is several times larger than the amount of the high-purity water suitable for drinking water but used for the production.

### BRIEF DESCRIPTION OF THE DRAWINGS

FIG. 1 is a semi-diagrammatical longitudinal section of an embodiment of the invention.

FIG. 2 is a semi-diagrammatical longitudinal section of another embodiment of the invention.

FIG. 3 is a semi-diagrammatical longitudinal section of still another embodiment of the invention.

### DETAILED DESCRIPTION

The production method according to the invention will be explained below. In the production method, a gas hydrate is obtained using a well-known method.

A gas hydrate can be obtained by having a gas capable of forming a gas hydrate and a low-purity water come into contact under a condition of forming gas hydrate and in a temperature is higher than the freezing point of the low-purity water.

It is common knowledge that a gas hydrate of structure I or structure II is formed, in a gas hydrate-forming phase (hydrate phase), at a temperature and a pressure between the temperature and pressure at the quadruple point (Q₁) of hydrate phase, ice phase, water phase and gas phase and the temperature and pressure at the quadruple point (Q₂) of hydrate phase, water phase, liquefied gas phase and gas phase.

A gas hydrate of structure H is formed, in a gas hydrate-forming phase (hydrate phase), at a temperature and a pressure between the temperature and pressure at the quintuple point (Q₁) of hydrate phase, ice phase, water phase, gas phase and liquid hydrocarbon phase and the temperature and pressure at the quintuple point (Q₂) of H-hydrate phase, ice phase, water phase, gas phase, liquid hydrocarbon phase. Among the structure types, structure II is preferably used because it can easily remove impurities such as salt be deposited on the external wall of the gas hydrate that is being in contact with a low-purity water, compared to structure I and structure H.

Therefore, the choice of a used gas limits a temperature and a pressure at which a gas hydrate is formed. More specifically, a gas hydrate is formed at a supercooling temperature lower than the equilibrium temperature at the hydrate phase between the quadruple points (Q₁ and Q₂) or at the hydrate phase between the quintuple points (Q₁ and Q₂). In the invention, the gas hydrate formation condition is a supercooled state. A supercooled state is necessary also because gas hydrate formation is an exothermal reaction.

Some types of gases are known as forming stable gas hydrates at the normal pressure and at specified temperatures (e.g., Non-Patent Document, Table 2.5).

Usually, in the presence of water, the lower the temperature, the lower the pressure enough to form gas hydrate. However, because the reaction speed decreases under a condition in which water turns into a solid, temperature below the freezing point of water is not practical for use. In this respect, because seawater has a lower freezing point than water containing no salt, it offers a wider scope of selection of gas hydrate formation conditions than that for water containing no salt.

From this aspect, if seawater is used as a raw material for water, a gas capable of forming a gas hydrate under a condition of a low pressure and a temperature higher than the freezing point of seawater is desirable. More specifically, a gas forming gas hydrate at not more than 5 MPa, preferably not more than 3 MPa, more preferably not more than 2 MPa, is used in terms of equipment costs.

From this point of view, for example, butane, isobutane, propane, cyclopropane, tetrahydrofuran, propylene, chlorine, CH₃CHF₂, or CH₃CClF₂ is desirable in terms of being capable of forming gas hydrate at an extremely low pressure. Note that it is unnecessary to consider the cost of a gas because it can be recycled.

The following can be said in terms of properties of the resulting gas hydrates. First, gas hydrates of large grain size are favorable in terms of separation from seawater and easy transportation. For example, methane hydrate is desirable, having average grain size of 50-150 μm.

Also, it is naturally desirable that the proportion of water (host molecules) in a gas hydrate is larger than that of gas (guest molecule).

For a certain type of gas hydrates, for example, methane hydrate or carbon dioxide hydrate, anomalous self-preservation is observed for a certain period of time under a condition outside the hydrate stability zone.

Methane is easy to handle because 50% of it can remain in a gas hydrate state at 280° K for about 10 minutes even outside the anomalous preservation regime of its gas hydrate (see Non-patent Document 1, FIGS. 3, 36) and, therefore, can be processed at the normal pressure. In this respect, a gas exhibiting an anomalous preservation phenomenon, for example, methane or carbon dioxide, is effective.

Gas hydrate forms crystal in which a gas is crystal nuclei. In the invention, it is desirable to enhance the crystal growth because the larger the size of a gas hydrate, the better the cleansing efficiency. A gas-liquid agitation method, which will be described later, is more desirable than a water spray method, which will also be described later, in terms of enhancing the crystal growth. Note that the number of types of gases capable of forming gas hydrates may be one or more and a gas may include a gas incapable of forming gas hydrate. Note that a gas may include a gas that does not form gas hydrate and one or more types of gases that are capable of forming gas hydrates may be used together.

A low-purity water, for example, seawater, that has been used in the gas hydrate formation process contains a considerable amount of highly-concentrated impurities that are deposited on the external wall of the gas hydrate. However, the amount of impurities dissolved in the low-purity water is just a minor part of the total. If the gas hydrate state is broken and “fresh water” could be obtained just by removing the low-purity water without being subject to the cleansing process which will be described later, what is obtained is a water with salinity only slightly reduced and most of the impurities remain fixed to the external walls of the gas hydrates, as described at the beginning of “Means for Solving the Problem” of this invention. Therefore, after the gas hydrate is formed, the low-purity water used in the gas hydrate formation is removed. The removal is carried out while substantially maintaining the gas hydrate state.

Then, the production method of the invention proceeds to cleansing the gas hydrate of impurities adhered to the gas hydrates while substantially maintaining the gas hydrate state.

For the cleansing water, it is desirable to use a low-purity water at first, and then change to higher-purity water gradually or in set order. Where a low-purity water for use as cleansing water is seawater, one example at first would be to use seawater (average salt concentration of about 3.5%) as a cleansing water, then salt water of about 2000 ppm salt concentration, and finally salt water of about 50 ppm salt concentration. In this case, it is desirable to remove salt adhered to the external wall of the gas hydrate, using the first used low-purity water as much as possible.

In principle, if cleansing water is a low-purity water (seawater), it is practicable to reduce the concentration of salt adhered to the external wall of the gas hydrate to the level of the salt concentration of seawater. Reducing the salt concentration to that level requires, for example, agitating the gas hydrate and the low-purity water so that both flow, or making the gas hydrate be in a fixed state and the low-purity water in a flowing state like spraying with water or showering, thereby removing the impurities adhered to the external wall of the gas hydrate.

Agitation without changing a liquid has no efficiency in the increased concentration of the solution. Therefore, desirable cleansing is a repetition of the steps of draining a used liquid from an agitation tank after agitation and supplying a new low-purity water to the tank for further agitation. This cleansing process results in a gas hydrate having an impurity concentration slightly higher than that of the low-purity water.

Cleansing is carried out in order to remove the impurities adhered to a gas hydrate as much as possible while retaining the gas hydrate structure. In order to retain the gas hydrate structure, the average temperature and pressure condition in the cleansing process should be kept in a range substantially maintaining the gas hydrate state. Meanwhile, in order to increase the water solubility of impurities adhered to the gas hydrate, it is preferable for the temperature of the cleansing water for removing the impurities to be higher. Therefore, the temperature of the cleansing water is determined taking the above two purposes into consideration. A condition in which the gas hydrate state is substantially maintained includes the anomalous self-preservation regime of methane or carbon dioxide. In the invention, the state in which “the gas hydrate state is substantially maintained” includes not only the state where some hydrates are broken due to the heat of the cleansing water in the process of mixing the cleansing water and the gas hydrate, but also the state where up to about 50% of the gas hydrates are broken. In this sense, a gas exhibiting the above-described anomalous self-preservation phenomena is convenient to use because it allows cleansing the gas hydrate under a condition in which the anomalous self-preservation regime occurs, from the beginning or in the middle of the cleansing process, depending on the time required for the process.

From this point of view, a desirable guest molecule is one having a high Q₂ or, when Q₂ does not exist or is not known, one capable of forming gas hydrate at a low pressure and a temperature not lower than 0° C.

In the former case, a guest molecule capable of forming gas hydrate at a temperature preferably not lower than 2° C., more preferably not lower than 3° C., and most preferably not lower than 5° C. is used. In the latter case, a guest molecule capable of forming gas hydrate at a pressure preferably not higher than 5 MPa, more preferably not higher than 3 MPa, and most preferably not higher than 1 MPa is used.

Examples of desirable gases include: chlorine (T at Q₂=28.3° C., P at Q₂=0.84 MPa), carbon dioxide (T at Q₂=9.9° C., P at Q₂=4.44 MPa), ethylene oxide, tetrahydrofuran, cyclopropane (T at Q₂=16.21° C., P at Q₂=0.559 MPa), CH₃CHF₂(T at Q₂=14.90° C., P at Q₂=0.430 MPa), CH₃CClF₂(T at Q₂=13.09° C., P at Q₂=0.229 MPa), C₃H₈ (T at Q₂=5.8° C., P at Q₂=0.556 MPa), H₂S (T at Q₂=29.7° C., Pat Q₂=2.239 MPa), and C₂H₄ (T at Q₂=14.8° C., P at Q₂=3.39 MPa). Of these gases, chlorine, cyclopropane, CH₃CHF₂, CH₃CClF₂, or C₃H₈ each capable of forming gas hydrate at a low pressure, or methane or carbon dioxide exhibiting the above-described anomalous self-preservation phenomena is desirable.

As a result of dedicated studies, one of inventors has discovered that the most desirable gas hydrate is one having isobutane as a guest molecule. And the most desirable a condition forming a gas hydrate is at 3-5° C. and 3-5 MPa, preferably at about 4° C. and about 4 MPa. This gas hydrate forms a crystal structure of type II and is capable of removing easily deposited or precipitated impurities. Then, the impurities adhered to the gas hydrate is preferably cleansed of with a high-purity water while substantially maintaining the above-described gas hydrate formation condition. For the high-purity water for use as cleansing water, it is desirable to change water while increasing the purity gradually or in set order, but it is undesirable to use water with impurity concentration of less than 100 ppm from the beginning.

In this way, it is feasible to make efficient use of water that has been used in cleansing and it is feasible to produce a large amount of a high-purity water suitable for drinking water using a small amount of a high-purity water different from the high-purity water to be obtained.

Cleansing with a water different from a low-purity water used for forming the gas hydrate needs to be carried out with a cleansing method that uses an amount of water less than that used in agitation.

One example of such method is a method including the steps of: preparing a net-like substance, piling up the gas hydrate on the net-like substrate, showering a high-purity water different from the high-purity water to be obtained, on the gas hydrate, and removing the upper gas hydrate from the site, utilizing the buoyancy of the gas hydrate having a specific gravity smaller than that of the showered high-purity water. In this case, it is desirable to make the showered high-purity water into fine droplets, i.e., it is desirable to flatten the gas hydrate piled up and so spray the showered high-purity water upon the flattened gas hydrate.

Another example of such method is a method including the steps of: preparing a cleansing tank, supplying the gas hydrate upward from a bottom part of the cleansing tank, showering a high-purity water different from the high-purity water to be obtained, on the gas hydrate, and removing the upper gas hydrate from the site of cleansing, using buoyancy of the gas hydrate having a specific gravity smaller than that of the showered high-purity water.

Still another method is a method including the steps of: preparing a net-like substance, piling up the gas hydrate on the net-like substrate, spreading the gas hydrate piled upon the net-like substrate so as to form a thin plate-like appearance, spraying a high-purity water different from the high-purity water to be obtained, on the spreaded gas hydrate, and draining the sprayed high-purity water through the net of the net-like substrate.

In the case of supplying the gas hydrate upward from the bottom of the cleansing tank, it is desirable to supply the gas hydrate together with water that has been used for cleansing and use the buoyancy of that water.

Then, by increasing the temperature in the gas hydrate state or decreasing the pressure in the gas hydrate state, each gas hydrate is made into a gas and high-purity water. The gas may be recycled or discharged into air if it will not cause harm to the environment.

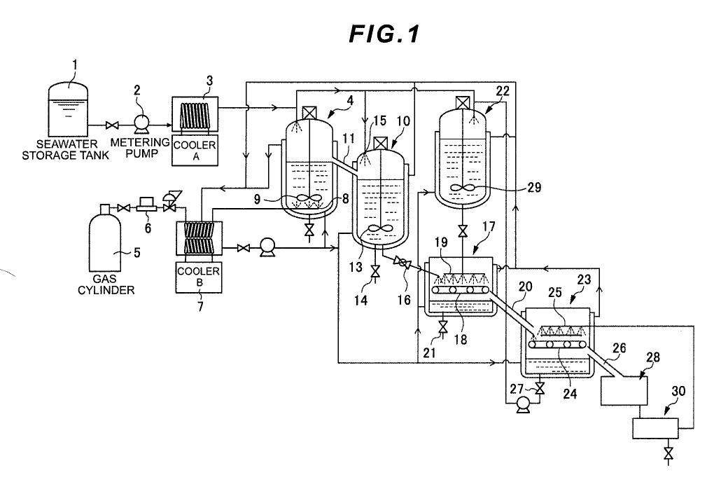

A desirable embodiment of the production apparatus according to the invention will be explained below with reference to the attached drawings. FIG. 1 is a semi-diagrammatical longitudinal section of an embodiment of the invention. The below explanation is an example where seawater is used as a low-purity water.

Seawater—a raw material for gas hydrate—is supplied from sea or a seawater storage tank 1 via a metering pump 2, a cooler 3 for cooling the seawater as necessary, and to a gas hydrate formation tank 4.

A gas—another raw material for gas hydrate—is supplied from a gas cylinder 5, via a compressor 6 as necessary, to a cooler 7 for cooling the gas as necessary, and to the gas hydrate formation tank 4, then discharged from a gas exhaust tube 8 provided in a lower part of the gas hydrate formation tank. For example, if cyclopropane is used as a raw material for gas hydrate, a stable gas hydrate can be obtained at 2.8° C. and the normal pressure (see Non-patent Document 1, Table 2.5), therefore, the cooler 3 is unnecessary depending on the site and season for the production. If chlorine is used as a raw material for a gas hydrate, a stable gas hydrate can be obtained at 9.7° C. and the normal pressure (see Non-patent Document 1, Table 2.5), so the cooler 3 is again unnecessary depending on the site and season for the production. Moreover, chlorine has also an effect of sterilizing the resulting water.

The gas and the seawater in the gas hydrate formation tank 4 are put under a condition of a temperature and a pressure for enabling gas hydrate formation, and agitated by an agitation unit 9, forming a gas hydrate.

Then, a gas hydrate starts to form. Because gas hydrate has a different specific gravity from seawater, they can be separated from each other due to that difference. For example, the specific gravity of methane gas hydrate is 0.94, which is lower than the specific gravity of seawater, therefore, methane gas hydrate floats on the top of the seawater in the gas hydrate formation tank 4. On the other hand, dimethylpentane hydrate has a specific gravity of 1.291 (calculated value), which is higher than the specific gravity of seawater. Therefore, dimethylpentane hydrate sinks. Therefore, this apparatus of this invention must be changed with those differences.

If the formed gas hydrate has a specific gravity lower than that of seawater, the gas hydrate is transported together with the seawater from the gas hydrate formation tank 4, via a communicating tube, 11 to a cleansing tank 10 to be subjected to the subsequent process of cleansing the gas hydrate of impurities such as salt adhered to the gas hydrate with a low-purity water (seawater).

On the other hand, if the gas hydrate has a specific gravity higher than that of seawater, the gas hydrate is separated from the seawater by centrifugation, mixed with a liquid for use in the next process, and transported to a tank to be subjected to the subsequent process. This method can also be employed in the case where the gas hydrate has a specific gravity lower than that of seawater.

The cleansing tank 10 for cleansing the formed gas hydrate with a low-purity water includes, in addition to an agitation unit 13, an outlet 14 for the low-purity water and an inlet 15 for a new low-purity water.

If the gas and the seawater have been agitated during the gas hydrate formation process in the gas hydrate formation tank 4, salt deposited on the surfaces of the gas hydrate is dissolved to some extent in the seawater. Therefore, the seawater in the gas hydrate formation process has a considerably high salt concentration and does not allow further salt dissolution. Therefore, if the gas hydrate in the cleansing tank 10 is accompanied by the seawater used in the gas hydrate formation process, only the seawater is drained from the outlet 14 under a condition in which the gas hydrate state is substantially maintained.

The following steps are repeated: closing the outlet 14, supplying a new low-purity water (seawater) to the cleansing tank 10 via the inlet 15, agitating the low-purity water (seawater) and the gas hydrate so that the salt deposited on the surfaces of the gas hydrate is dissolved in the low-purity water (seawater) as much as possible, draining the low-purity water now having increased salt concentration due to the agitation from the outlet 14, and supplying a more new low-purity water for further agitation. Instead of agitation, the gas hydrate may be cleansed with flowing water. Needless to say, these steps are carried out under condition in which the gas hydrate state is substantially maintained.

When an increase in the salt concentration can no longer be observed in agitation, both the gas hydrate and the seawater are transported via a ball valve 16 to a cleansing apparatus 17 for cleansing with a middle-purity water to be subjected to the subsequent process.

The cleansing apparatus 17 for cleansing with a middle-purity water is composed of: a net-like substrate 18 that rotates as a belt conveyor; a spray apparatus 19 supplied with a middle-purity water; a communicating tube 20; and an outlet 21. The term “middle-purity water” is used to refer to water with a purity higher than that of a low-purity water but lower than that of a high-purity water which will be described later.

As a middle-purity water, usually, a waste water after cleansing using a high-purity water, which will be described later, is directly used. If necessary, a high-purity water obtained according to the invention or a low-purity water may be added to the waste water in a mixing tank 22 to produce a mixture.

After the gas hydrate is transported to the cleansing apparatus 17 with the middle-purity water, together with cleansing water used at the cleansing tank 10, via the ball valve 16, the gas hydrate is spread on the net-like substrate 18 that is rotating as a belt conveyor. If necessary, the net-like substrate 18 is vibrated so that a even thin sheet-like appearance of gas hydrate can be formed on the net-like substrate 18.

The gas hydrate is then cleansed with a middle-purity water sprayed by the spray 19, and then transported from the end of the belt conveyor, via the communicating tube 20, to a cleansing apparatus 23 for cleansing with a high-purity water. Meanwhile, the middle-purity water used for the cleansing is drained from the outlet 21. The above-described steps of cleansing with a middle-purity water in the cleansing apparatus 17 are also carried out under a condition in which the gas hydrate state is substantially maintained.

Like the cleansing apparatus 17, the cleansing apparatus 23 for cleansing with a high-purity water is composed of: a net-like substrate 24 that rotates as a belt conveyor; a spray 25 supplied with a high-purity water; a communicating tube 26; and an outlet 27. The term “a high-purity water” refers to water with almost the same level of purity as the high-purity water produced in the invention.

The gas hydrate transported via the communicating tube 20 to the cleansing apparatus 23 for cleansing with a high-purity water, falls on the net-like substrate 24 rotating as a belt conveyor. If necessary, the net-like substrate 24 is vibrated so that a even thin sheet-like appearance of gas hydrate can be formed on the net-like substrate 24. The gas hydrate is then cleansed with a high-purity water sprayed from above by the spray apparatus 25, and then transported from the end of the belt conveyor, via the communicating tube 26, to a gas hydrate decomposition tank 28.

Meanwhile, the high-purity water used for the cleansing is drained through the net of the net-like substrate 24, accumulates in the bottom of the apparatus 23 for cleansing with the high-purity water, and pumped up from the outlet 27 to the mixing tank 22 in which an agitation apparatus 29 homogenizes the salt concentration of the cleansing with the high-purity water so as to use it as a middle-purity cleansing water in the cleansing apparatus 17.

In the gas hydrate decomposition tank 28, a condition maintaining the gas hydrate is out, so the gas hydrate decomposes.

More specifically, the gas hydrate is put under a condition of a temperature and a pressure that allows decomposition of the gas hydrate into a gas and water. The resulting water is then transported to a fresh water tank 30 and the gas may be discharged if it does not harm the environment, or recycled (not shown in the drawing). In the case of recycling of the gas, the gas cylinder 5 is unnecessary and the gas returns from the gas outlet, via the compressor 6, to the cooler 7.

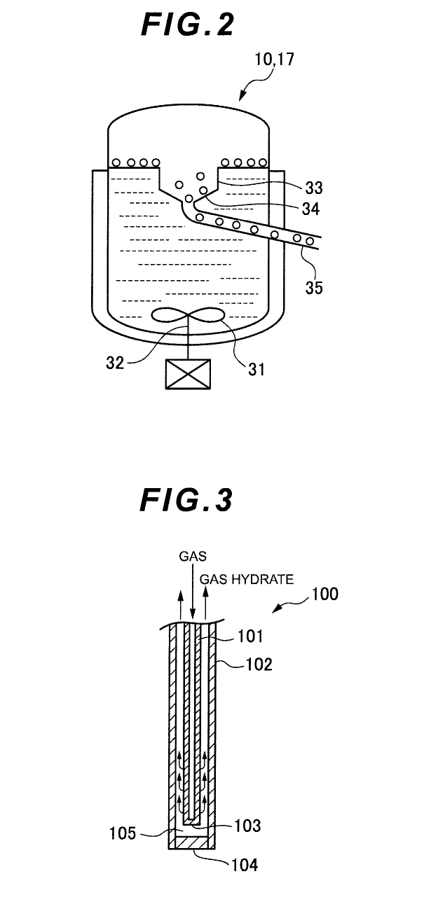

If a specific gravity of gas hydrate is less than 1.0, a cleansing tank may be of the structure shown in FIG. 2. The cleansing tank 10,17 may have agitation wings 31 and an agitation axis 32 in a lower part of the cleansing tank 10,17, a funnel 33 in the upper central part, and a communicating tube 35 extending from the bottom 34 of the funnel 33, through the side wall of the cleansing tank 10,17, to a section for a subsequent process. With this structure, the gas hydrate cleansed in agitation is supplied from the upper end of the funnel 33, through the funnel itself and the communicating tube, to a section for a subsequent process. The above explanation is for the case where the gas hydrate formation tank 4 and the cleansing tank 10 are separately provided, however, the cleansing tank 10 can also serve as a gas hydrate formation tank and so the gas hydrate formation tank 4 can be omitted.

The above explanation is for an example in which gas hydrates are formed on land. However, gas hydrate may be formed at the subsurface part of sea. An apparatus for gas hydrate formation at the subsurface part of sea will be explained below with reference to FIG. 3. FIG. 3 is a semi-diagrammatical longitudinal section showing a tip of a gas hydrate formation tube 100 located in the deep sea. The term “deep sea” refers to a place in the sea where the seawater temperature is not higher than 10° C. Needless to say, the depth at which the gas hydrate formation tube is positioned varies depending on latitude.

The lower the seawater temperature is, decrease in temperature required for the gas hydrate formation condition is enough to be small. However, the pressure required for the gas increases with the depth of the water. Therefore, an appropriate depth is selected taking the advantage and the disadvantage of the above conditions into consideration. The gas hydrate formation tube 100 located in the deep sea is of a double tube structure composed of an internal tube 101 and an external tube 102. Of these tubes, the external tube 102 is of a length reaching the deep sea and has a porous film 104 permeable to seawater at its tip.

A raw-material gas for gas hydrate formation is supplied from a pressurized gas storage tank (not shown in the drawing) to the internal tube 101 and then to the tip of the gas hydrate formation tube 100.

The internal tube 101 has, in the vicinity of its tip, a plurality of pores 103 which a gas passes through from the internal tube 101 to the external tube 102. The seawater passes through the porous film 104 and enters the space 105 between the external tube 102 and the internal tube 101 with a high pressure.

Meanwhile, the gas in the internal tube 101 also enters the space 105 through the pores 103. If the pressure and temperature in the space 105 satisfy the gas hydrate formation condition, gas hydrate is formed. That is, the space 105 is the site of gas hydrate formation. In this respect, it is desirable that the temperature of the seawater is relatively low.

The formed gas hydrate floats through the space between the internal tube 101 and the external tube 102 to the top due to both pressure of the pressure of the seawater entering the space 105 through the porous film 104 and the gas pressure entering the space 105 through the pores 103 of the internal tube 101. The gas hydrate is then supplied, together with the seawater, to the cleansing tank 10 for cleansing with low-purity water. Subsequent steps are the same as those explained above, so their explanations will be omitted.

Although all the explanations above are for the case where seawater is used, the invention can also be utilized in the same manner with sewage. Sewage may contain salt as well as other impurities and these are adhered to the external walls of the gas hydrate, so it is necessary to use appropriate means to remove them as much as possible. As for the water-soluble impurities, the same method used for seawater may be employed.

In general, after removing impurities that can be removed by filters, phase-separable parts in the sewage in the tank 1 are separated into an aqueous phase containing water-soluble impurities and an oil phase containing oily impurities by a method such as still standing or centrifugation. The aqueous phase is handled with a method similar to the method used for seawater. On the other hand, the oil phase containing water-insoluble impurities such as organics, if they can be used as fuels or their specific impurities can be used for purposes other than fuels, is handled with a method for, for example, removing impurities other than the specific impurities by using, for example, an absorbent.

### INDUSTRIAL APPLICABILITY

The invention enables producing, from low-purity water such as seawater or sewage, high-purity water suitable for drinking water. Waste water generated during the production process can be recycled as, for example, agricultural water, industrial water, or household water. Moreover, a gas used in the production can also be recycled, exerting no burden on the environment.

### DESCRIPTION OF REFERENCE NUMERALS

1 seawater storage tank
2 metering pump
3 cooler
4 gas hydrate formation tank
5 gas cylinder
6 compressor
7 cooler
8 gas exhaust tube
9 agitation means
10 cleansing tank for cleansing with low-purity water
11 communicating tube
13 agitation unit
14 outlet for low-purity water after being agitated
15 Inlet for a new low-purity water
16 ball valve
17 cleansing apparatus for cleansing with middle-purity water
18 net-like substrate rotating as a belt conveyor
19 spray for a middle purity water
20 communicating tube
21 outlet
22 mixing tank
23 cleansing apparatus for cleansing with high-purity water
24 net-like substrate rotating as a belt conveyor
25 spray for a high-purity water
26 communicating tube
27 outlet
28 gas hydrate decomposition tank
29 agitation apparatus
30 fresh water tank
31 agitation wings
32 agitation axis
101 internal tube
102 external tube
103 pores
104 porous film
105 space (gas hydrate formation site)

What is claimed is:

1. A method for producing a high-purity water from a low-purity water, comprising the steps of:
producing a gas hydrate suspended in the low-purity water by having a gas capable of forming the gas hydrate and the low-purity water come into contact under a condition of forming the gas hydrate and in a temperature higher than the freezing point of the low-purity water;
cleansing the gas hydrate of impurities adhered to the gas hydrate with a cleansing water up to the level that the high-purity water to be obtained by a subsequent process is a drinking water while substantially maintaining the gas hydrate state; and
decomposing the gas hydrate into a gas and a high-purity water by at least one of increasing the temperature in the gas hydrate state and decreasing the pressure in the gas hydrate state; and
these steps carried out in the above order.

2. The method for producing a high-purity water from a low-purity water according to claim 1, further comprising a step of selecting a gas that forms a gas hydrate of structure II, wherein the selected gas is used in the step of producing the gas hydrate.

3. The method for producing a high-purity water from a low-purity water according to claim 1, wherein the cleansing water is a low-purity water in the beginning and is changed to a water with higher purity gradually or in set order.

4. The method for producing a high-purity water from a low-purity water according to claim 3, wherein the step of cleansing the gas hydrate includes the steps of:
preparing a cleansing tank;
removing the low-purity water used for forming the gas hydrate from said cleansing tank, remaining the gas hydrate;
supplying a low-purity water different from the low-purity water used for forming the gas hydrate to said cleansing tank;
agitating the gas hydrate and the low-purity water different from the low-purity water used for forming the gas hydrate; and
removing the above-stated low-purity water containing dissolved impurities deposited on the surfaces of the gas hydrate.

5. The method for producing a high-purity water from a low-purity water according to claim 3, wherein the step of cleansing the gas hydrate includes the steps of:
preparing a net-like substance;
piling up the gas hydrate on said net-like substrate;
showering a high-purity water different from the high-purity water to be obtained on the gas hydrate; and,
removing from the cleansing site the upper gas hydrate having a specific gravity smaller than that of said showered high-purity water.

6. The method for producing a high-purity water from a low-purity water according to claim 3, wherein the step of cleansing the gas hydrate includes the steps of:
preparing a cleansing tank;
supplying the gas hydrate upward from the bottom of said cleansing tank;
showering on the gas hydrate a high-purity water different from the high-purity water to be obtained; and
removing the upper gas hydrate from the site of cleansing, using buoyancy of the gas hydrate having a specific gravity smaller than that of said showered high purity water.

7. The method for producing a high-purity water from a low-purity water according to claim 2, wherein the step of cleansing the gas hydrate includes the steps of:
preparing a net-like substrate;
piling up the gas hydrate on said net-like substrate;
spreading the gas hydrate piled up on said net-like substrate so as to form a thin plate-like appearance;
spraying a high-purity water different from the high-purity water to be obtained, on said spread gas hydrate; and
draining the sprayed high-purity water through the net of the net-like substrate.

8. The method for producing a high-purity water from a low-purity water according to claim 1, wherein the low-purity water is seawater.

9. The method for producing a high-purity water from a low-purity water according to claim 1, wherein the low-purity water is sewage.

10. The method for producing a high-purity water from a low-purity water according to claim 1, wherein the gas hydrate formed with isobutane is of structure II.

11. The method for producing high-purity water from low-purity water according to claim 8, wherein the gas hydrate is formed under a condition of a temperature 3-5° C. and a pressure 3-5 MPa.

12. An apparatus for producing a high-purity water from a low-purity water, comprising:
a supply unit for supplying a raw material including a gas and the low-purity water for a gas hydrate;
a gas hydrate formation tank for forming the gas hydrate under a condition for gas hydrate formation;
a cleansing tank capable of serving also as the gas hydrate formation tank, for removing the low-purity water used in the gas hydrate formation and cleansing the gas hydrate of impurities deposited on an external wall of the gas hydrate with a cleansing water while substantially maintaining the gas hydrate up to the level that the high-purity water to be obtained is a drinking water; and
a gas hydrate decomposition tank for obtaining the high-purity water by at least one of increasing a temperature and decreasing a pressure in the gas hydrate state.

13. The apparatus for producing a high-purity water from a low-purity water according to claim 12, wherein the cleansing tank includes a cleansing tank for cleansing the gas hydrate with the low-purity water, and a cleansing apparatus with a high-purity water different from the high-purity water to be obtained, for cleansing the gas hydrate cleansed with the low-purity water.

14. The apparatus for producing a high-purity water from a low-purity water according to claim 13, a cleansing tank for cleansing the gas hydrate with a low-purity water includes an agitation unit, an outlet for the low-purity water after agitation, and an inlet for a new low-purity water.

15. The apparatus for producing a high-purity water from a low-purity water according to claim 13, wherein the cleansing apparatus for cleansing the gas hydrate with a high-purity water different from the high-purity water to be obtained, comprising:
means for piling up the gas hydrate on a net-like substrate;
means for supplying the gas hydrate upward;
means for showering a high-purity water different from the high-purity water to be obtained on the gas hydrate; and
means for transporting the gas hydrate having a specific gravity smaller than that of said showered high-purity water from an outlet provided in an upper part of the side wall of the cleansing tank to the hydrate decomposition tank.

16. The apparatus for producing a high-purity water from a low-purity water according to claim 13, wherein the cleansing apparatus for cleansing the gas hydrate with a high-purity water different from the high-purity water to be obtained, comprising:
means for supplying the gas hydrate upward from a bottom part of the cleansing tank;
means for showering a high-purity water different from the high-purity water to be obtained, on the gas hydrate; and
means for transporting the upper gas hydrate having a specific gravity smaller than said showered high-purity water from an outlet provided in an upper part of the side wall of the cleansing tank to the hydrate decomposition tank.

17. The apparatus for producing a high-purity water from a low-purity water according to claim 13, wherein the cleansing apparatus for cleansing the gas hydrate with a high-purity water different from the high-purity water to be obtained comprising:
means for piled up the gas hydrate on a net-like substrate;
means for spreading the gas hydrate piled up on the net-like substrate so as to form a thin plate-like appearance;
means for spraying on said spread gas hydrate a high-purity water different from the high-purity water to be obtained; and
means for draining the sprayed high-purity water through the net of the net-like substrate.

18. The apparatus for producing a high-purity water from a low-purity water according to claim 15, wherein the net-like substrate is of a belt conveyor type.

19. The apparatus for producing a high-purity water from a low-purity water according to claim 12, wherein the cleansing tank includes:
an agitation wing and an agitation axis in a lower part of the cleansing tank;
a funnel in an upper central part; and
a communicating tube extending from a bottom part of the funnel through a side wall of the cleansing tank to a section for a subsequent process so that the gas hydrate cleansed in agitation travels through the communicating tube from an upper end of the funnel to a section for the subsequent process.

20. An apparatus for producing a high-purity water from seawater, comprising:
a double tube of a length reaching the deep sea, wherein a gas hydrate is formed in its tip, the double tube including:
an internal tube which a raw material gas for a gas hydrate is supplied to; and an external tube which the formed gas hydrate passes through,
the double tube also having: a space allowing to enter the gas between the internal tube and the external tube through a pore in a vicinity of the tip of the internal tube; and
a porous film permeable to seawater at the tip of the external tube;
a cleansing tank for removing the seawater used in the gas hydrate formation and cleansing the gas hydrate with cleansing water up to the level that the high-purity water to be obtained is a drinking water while substantially maintaining the gas hydrate state; and
a gas hydrate decomposition tank for obtaining high-purity water by at least one of increasing the temperature, and decreasing the pressure in the gas hydrate state which has been kept for the gas hydrate.

21. The apparatus for producing a high-purity water from seawater according to claim 20, wherein the cleansing tank includes a cleansing tank for cleansing the gas hydrate with a low-purity water, and a cleansing apparatus for cleansing the gas hydrate cleansed with the low-purity water, with a high-purity water different from the high-purity water to be obtained.
